(19) United States
(12) Patent Application Publication
(10) Pub. No.: US 2014/0370286 A1
(43) Pub. Date: Dec. 18, 2014

(54) HALOGEN-FREE FLAME-RETARDANT WIRE

(71) Applicant: Hitachi Metals, Ltd., Tokyo (JP)

(72) Inventors: Makoto IWASAKI, Hitachi (JP); Mitsuru HASHIMOTO, Hitachi (JP)

(21) Appl. No.: 14/303,159

(22) Filed: Jun. 12, 2014

(30) Foreign Application Priority Data
Jun. 14, 2013 (JP) 2013-125617

(51) Int. Cl. H01B 3/02; H01B 7/295; H01B 3/44

(52) U.S. Cl. CPC H01B 3/02; H01B 3/441; H01B 3/448; H01B 7/295
USPC 428/383; 428/389

(57) ABSTRACT

A halogen-free flame-retardant wire includes a conductor, and a single insulation layer or a plurality of insulation layers formed by covering an outer periphery of the conductor with a halogen-free flame-retardant resin composition. The single insulation layer or an outermost insulation layer of the plurality of insulation layers includes a halogen-free flame-retardant resin composition including a base polymer including an ethylene-vinyl acetate copolymer (EVA) of not less than 25 mass % in a vinyl acetate content (VA content) or a polyethylene (PE) with a melting peak at 115 to 140° C. measured by a differential scanning calorimetry (DSC), and a metal hydroxide mixed in an amount of 150 to 300 parts by mass per 100 parts by mass of the base polymer. A mass change rate of the single insulation layer or the outermost insulation layer after 24-hour immersion in xylene at 110° C. is not more than 420%.

The present application is based on Japanese patent application No. 2013-125617 filed on Jun. 14, 2013, the entire contents of which are incorporated herein by reference.

### BACKGROUND OF THE INVENTION

1. Field of the Invention

The invention relates to a halogen-free flame-retardant wire using a halogen-free flame-retardant resin composition that is excellent in oil resistance and ease of handling.

2. Description of the Related Art

According as awareness of environmental issues globally increases, halogen-free materials are demanded which do not generate halogen gas upon combustion. In addition, it is necessary to add a large amount of halogen-free flame retardant such as metal hydroxide in order to suppress flame propagation in case of fire and thereby to obtain high flame retardancy.

Further, electric wires used in railway rolling stocks, vehicles and robots etc. need to have high oil resistance according to the use environment. It is known to use a polymer having high crystallinity or polarity so as to obtain a high oil resistance (see e.g. JP-A-2010-097881).

### SUMMARY OF THE INVENTION

Adding a large amount of halogen-free flame retardant may cause the problem that mechanical characteristics decrease. Also, the melt fluidity may decrease so that molding machines available therefor are limited. On the other hand, it is exemplary that a polymer having a high crystallinity is used so as to obtain a high oil resistance. For example, polypropylene, which has especially high melting point among polyolefins, is effective to improve the oil resistance. However, the material is low in flame retardancy and therefore it needs to include a large amount of a flame retardant such as a metal hydroxide. In case of using this measure, the material may significantly decrease in breaking elongation since the high-melting-point material must contain much crystal and be strongly affected by the large amount of the flame retardant added. If the material having the extremely high polarity is used for the insulation layer of electric wires, the wires may stick to each other so that it is difficult to handle the wires.

It is an object of the invention to provide a halogen-free flame-retardant wire that is excellent in oil resistance and handling property.

(1) According to one embodiment of the invention, a halogen-free flame-retardant wire comprises:

a conductor; and

a single insulation layer or a plurality of insulation layers formed by covering an outer periphery of the conductor with a halogen-free-retardant resin composition,

wherein the single insulation layer or an outermost insulation layer of the plurality of insulation layers comprises a halogen-free flame-retardant resin composition comprising:

a base polymer including an ethylene-vinyl acetate copolymer (EVA) of not less than 25 mass % in a vinyl acetate content (VA content) or a polyethylene (PE) with a melting peak at 115 to 140° C. measured by a differential scanning calorimetry (DSC); and a metal hydroxide mixed in an amount of 150 to 300 parts by mass per 100 parts by mass of the base polymer, and
wherein a mass change rate of the single insulation layer or the outermost insulation layer after 24-hour immersion in xylene at 110° C. is not more than 420%.

In the above embodiment (1) of the invention, the following modifications and changes can be made.

(i) The polyethylene (PE) is silane-grafted.

(ii) The base polymer further includes an acid-modified polyolefin.

(iii) The halogen-free flame-retardant resin composition is crosslinked.

### Effects of the Invention

According to one embodiment of the invention, a halogen-free flame-retardant wire can be provided that is excellent in oil resistance and handling property.

### BRIEF DESCRIPTION OF THE DRAWINGS

Next, the present invention will be explained in more detail in conjunction with appended drawings, wherein:

FIG. 1 is a schematic cross sectional view showing a halogen-free flame-retardant wire in a first embodiment in the present invention; and

FIG. 2 is a schematic cross sectional view showing a halogen-free flame-retardant wire in a second embodiment of the invention.

### DETAILED DESCRIPTION OF THE PREFERRED EMBODIMENTS

### Summary of Embodiments

Halogen-free flame-retardant wires in the present embodiments are provided with a conductor and one or plural insulation layers formed by covering the outer periphery of the conductor with a halogen-free flame-retardant resin composition, wherein a halogen-free flame-retardant resin composition constitutes a single insulation layer in case of providing the insulation layer with a single-layer structure or constitutes the outermost insulation layer located on the outermost side in case of providing the insulation layer with a multilayer structure, and the halogen-free flame-retardant resin composition is composed of a base polymer containing ethylene-vinyl acetate copolymer (EVA) with a vinyl acetate content (VA content) of not less than 25 mass % or polyethylene (PE) with a melting peak at 115 to 140° C. as measured by differential scanning calorimetry (DSC) method and metal hydroxide mixed in an amount of 150 to 300 parts by mass per 100 parts by mass of the base polymer, and mass change rate in the single insulation layer or the outermost insulation layer after 24-hour immersion in xylene at 110° C. is not more than 420%.

### EMBODIMENTS

Halogen-free flame-retardant wires in the present embodiments are provided with a conductor and one or plural insulation layers formed by covering the outer periphery of the conductor with a halogen-free flame-retardant resin composition, wherein a halogen-free flame-retardant resin composition constitutes a single insulation layer in case of providing the insulation layer with a single-layer structure or constitutes the outermost insulation layer located on the outermost side in case of providing the insulation layer with a multilayer structure, and the halogen-free flame-retardant resin composition is composed of a base polymer including ethylene-vinyl acetate copolymer (EVA) with a vinyl acetate content (VA content) of not less than 25 mass % or polyethylene (PE) with a melting peak at 115 to 140° C. as measured by differential scanning calorimetry (DSC) method and metal hydroxide mixed in an amount of 150 to 300 parts by mass per 100 parts by mass of the base polymer, and mass change rate in the single insulation layer or the outermost insulation layer after 24-hour immersion in xylene at 110° C. is not more than 420%.

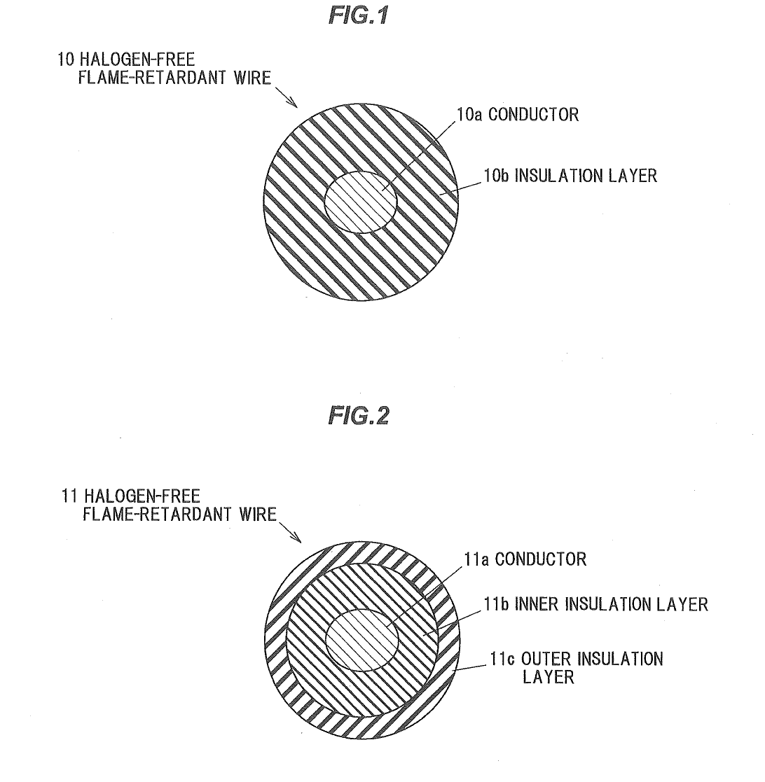

The embodiments of the halogen-free flame-retardant wire of the invention will be specifically described below in reference to the drawings. Firstly, a halogen-free flame-retardant resin composition used in the present embodiments will be described. Then, halogen-free flame-retardant wires in the present embodiments, the wire shown in FIG. 1 as the first embodiment and the wire shown in FIG. 2 the second embodiment, will be further specifically described.

I. Halogen-Free Flame-Retardant Resin Composition

The halogen-free flame-retardant resin composition used in the present embodiments includes a base polymer including ethylene-vinyl acetate copolymer (EVA) with a vinyl acetate content (VA content) of not less than 25 mass % or polyethylene (PE) with a melting peak at 115 to 140° C. as measured by differential scanning calorimetry (DSC) method and also includes metal hydroxide mixed in an amount of 150 to 300 parts by mass per 100 parts by mass of the base polymer. Each component will be specifically described below.

1. Base Polymer

As described above, the base polymer of the halogen-free flame-retardant resin composition used for the halogen-free flame-retardant wires in the present embodiments is configured to contain ethylene-vinyl acetate copolymer (EVA) with a vinyl acetate content (VA content) of not less than 25 mass % or polyethylene (PE) with a melting peak at 115 to 140° C. as measured by differential scanning calorimetry (DSC) method.

(1-1) Ethylene-Vinyl Acetate Copolymer (EVA)

Ethylene-vinyl acetate copolymer (EVA) constituting the base polymer used in the present embodiments needs to have a vinyl acetate content (VA content) of not less than 25 mass %. When less than 25 mass %, oil resistance is not enough. The upper limit of the VA content in the base polymer is preferably 50 mass % from the viewpoint of adhesion between wires.

The VA content in the base polymer in case of using EVA as the base polymer is derived from the following formula (I) when 1 or 2 or 3 . . . k . . . or n types of polymers are used.

(VA content in Base polymer)=ΣXₖYk (1)

X: VA content in Polymer k (mass %)
Y: Percentage of Polymer k in the total of polymers
k: natural number

(1-2) Polyethylene (PE)

Polyethylene (PE), which constitutes the base polymer in the present embodiments and is used as an alternative of the ethylene-vinyl acetate copolymer (EVA), needs to have a melting peak at 115 to 140° C. as measured by differential scanning calorimetry (DSC) method. Oil resistance is not enough when the melting peak is less than 115° C. On the other hand, when the melting peak is more than 140° C., breaking elongation decreases if a large amount of metal hydroxide is added.

Examples of applicable PE include very low-density polyethylene, low-density polyethylene and high-density polyethylene.

In addition, these polyethylenes may be silane-grafted. Silane grafting provides good adhesion with metal hydroxide, thereby improving mechanical strength. Further addition of a silanol condensation catalyst allows silane crosslinking to occur after extrusion molding, which eliminates a crosslinking process. For silane crosslinking, a silane compound is used. The silane compound needs to have a group capable of reacting with the polymer and an alkoxy group which forms cross links by silanol condensation. Examples of the silane compound include vinylsilane compounds such as vinyltrimethoxysilane, vinyltriethoxysilane and vinyl tris(β-methoxyethoxy)silane; aminosilane compounds such as γ-aminopropyltrimethoxysilane, γ-aminopropyltriethoxysilane, N-β(aminoethyl) γ-aminopropyltrimethoxysilane, (β-aminoethyl) γ-aminopropylmethyldimethoxysilane and N-phenyl-γ-aminopropyltrimethoxysilane; epoxy silane compounds such as β-(3, 4-epoxycyclohexyl)ethyltrimethoxysilane, γ-glycidoxypropyltrimethoxysilane and γ-glycidoxypropylmethyldiethoxysilane; acrylsilane compounds such as γ-methacryloxypropyltrimethoxysilane; polysulfide silane compounds such as bis(3-(triethoxysilyl)propyl)disulfide and bis(3-(triethoxysilyl)propyl)tetrasulfide; and mercaptosilane compounds such as 3-mercaptopropyltrimethoxysilane and 3-mercaptopropyltriethoxysilane, etc.

Meanwhile, the silanol condensation catalyst may be dibutyltin dilaurate, dibutyltin diacetate, dibutyltin dioctoate, stannous acetate, stannous caprylate, zinc caprylate, lead naphthenate or cobalt naphthenate, etc.

(1-3) Other Base Polymer Components

Other than the ethylene-vinyl acetate copolymer (EVA) or polyethylene (PE), acid-modified polyolefin may be added as a component constituting the base polymer used in the present embodiments. For example, in either case of using EVA or PE as the base polymer, addition of acid-modified polyolefin to the base polymer for the purpose of improving mechanical strength provides good adhesion with metal hydroxide, thereby improving mechanical strength. Examples of the acid include maleic acid, maleic anhydride and fumaric acid.

2. Metal Hydroxide

Examples of metal hydroxide (halogen-free flame retardant) in the halogen-free flame-retardant resin composition used for the halogen-free flame-retardant wires in the present embodiments include magnesium hydroxide, aluminum hydroxide, calcium hydroxide, and these hydroxides with dissolved nickel. As compared to calcium hydroxide of which endothermic quantity at the time of decomposition is about 1900 J/g, aluminum hydroxide and magnesium hydroxide are preferable due to high endothermic quantity of 1500 to 1600 J/g and resulting good flame retardancy. These hydroxides can be used alone or as a mixture of two or more thereof.

In addition, these metal hydroxides may be used after surface treatment with a silane coupling agent, titanate-based coupling agent, fatty acid such as stearic acid or calcium stearate, or fatty acid metal salt, etc., from the viewpoint of dispersibility. In addition, other metal hydroxides may be added in an appropriate amount.

The mixed amount of the metal hydroxide needs to be 150 to 300 parts by mass per 100 parts by mass of the base polymer, and is preferably 180 to 250 parts by mass. Sufficient flame retardancy is not obtained when less than 150 parts by mass while mechanical characteristics such as breaking elongation decrease when more than 300 parts by mass.

3. Other Components to be Mixed

To the halogen-free flame-retardant resin composition used for the halogen-free flame-retardant wires in the present embodiments, it is possible, if necessary, to mix other components such as cross-linking agents, crosslinking aids, flame-retardant aid, ultraviolet absorbers, light stabilizers, softeners, lubricants, colorants, reinforcing agents, surface active agents, inorganic fillers, plasticizers, metal chelators, foaming agents, compatibilizing agents, processing aids and stabilizers, in addition to the above-mentioned base polymer and metal hydroxides.

4. Crosslink

The halogen-free flame-retardant resin composition used for the halogen-free flame-retardant wires in the present embodiments is preferably crosslinked from the viewpoint of improving mechanical characteristics. The cross-linking method is, e.g., an electron beam crosslinking in which an electron beam is irradiated after molding, a chemical cross-linking method in which a halogen-free flame-retardant resin composition with a pre-mixed cross-linking agent (e.g., organic peroxide or sulfur compound) is crosslinked by heating after molding, or silane crosslinking, etc.

5. Mass Change Rate by Hot Xylene

When the halogen-free flame-retardant resin composition in the present embodiments is molded into, e.g., an insulation layer of an electric wire, mass change rate of the insulation layer (or the outermost insulation layer in case of having a multilayer structure) is not more than 420% after 24-hour immersion in xylene at 110° C. When the mass change rate is more than 420%, insulation layers adhere (stick) to each other and it is difficult to handle. When further immersing in oil heated to a high temperature, the oil is dispersed in the insulation layer and mechanical strength decreases.

II. Halogen-Free Flame-Retardant Wire

A halogen-free flame-retardant wire 10 is the halogen-free flame-retardant wire in the first embodiment of the invention, and is provided with a conductor 10a and a single insulation layer (monolayer insulation) 10b formed by covering the outer periphery of the conductor 10a with the halogen-free flame-retardant resin composition described above, as shown in FIG. 1.

Meanwhile, a halogen-free flame-retardant wire 11 is the halogen-free flame-retardant wire in the second embodiment of the invention and is provided with a conductor 11a and plural insulation layers (inner and outer insulation layers) 11b and 11c formed by covering the outer periphery of the conductor 11a with the halogen-free flame-retardant resin composition as shown in FIG. 2, wherein the outer insulation layer 11c is formed of the halogen-free flame-retardant resin composition described above.

The mass change rate of the insulation layer (or the outermost insulation layer in case of having a multilayer structure) used in the present embodiments is not more than 420% after 24-hour immersion in xylene at 110° C. As mentioned above, when the mass change rate is more than 420%, insulation layers adhere to each other and it is difficult to handle. When further immersing in oil heated to a high temperature, the oil is dispersed in the outermost insulation layer and mechanical strength decreases.

A separator or braid, etc., may be further provided, if required.

When the insulation layer has a multilayer structure, insulation layers other than the outermost layer can be formed by extrusion coating of, e.g., a polyolefin resin. Examples of such a polyolefin resin include low-density polyethylene, EVA, ethylene ethyl acrylate copolymer, ethylene methyl acrylate copolymer, ethylene-glycidyl methacrylate copolymer and maleic anhydride polyolefin, etc., which can be used alone or as a mixture of two or more. Rubber materials are also applicable and examples thereof include ethylene-propylene copolymer rubber (EPR), ethylene-propylene-diene terpolymer rubber (EPDM), acrylonitrile butadiene rubber (NBR), hydrogenated NBR (HNBR), acrylic rubber, ethylene-acrylic ester copolymer rubber, ethylene-octene copolymer rubber (EOR), ethylene-vinyl acetate copolymer rubber, ethylene-butene-1 copolymer rubber (EBR), butadiene-styrene copolymer rubber (SBR), isobutylene-isoprene copolymer rubber (IIR), block copolymer rubber having a polystyrene block, urethane rubber and phosphazene rubber, etc., which can be used alone or as a mixture of two or more. In addition, the material is not limited to the polyolefin resins and rubber materials listed above as long as insulation properties are obtained.

### EXAMPLES

The halogen-free flame-retardant wire of the invention will be described in more detail below in reference to Examples. Here, ethylene-vinyl acetate copolymer (EVA) is used as the base polymer of the halogen-free flame-retardant resin composition in Examples 1 to 3, polyethylene (PE) is used as the base polymer in Examples 4 and 5, and silane-grafted polyethylene (PE) is used as the base polymer in Example 6. It should be noted that the following examples are not intended to limit the invention in any way.

### Example 1

The following components were mixed in the amounts described below (or see Table 1). Note that, the vinyl acetate content (VA content) in the base polymer was 25.2 mass % which was calculated from the above formula (I).

65 parts by mass of ethylene-vinyl acetate copolymer (EVA) (trade name: EV550 manufactured by Du Pont-Mitsui Polychemicals Co., Ltd., VA content of 14%) as the base polymer

35 parts by mass of ethylene-vinyl acetate copolymer (EVA) (trade name: EV45X manufactured by Du Pont-Mitsui Polychemicals Co., Ltd., VA content of 46%) as the base polymer

2 parts by mass of organic peroxide (trade name: Perbutyl P manufactured by NOF Corporation) as another component to be mixed

150 parts by mass of magnesium hydroxide (trade name: Kisuma 5L manufactured by Kyowa Chemical Industry Co., Ltd.) as metal hydroxide

The components mixed in the amounts shown above were kneaded by a 14-inch roll, thereby making the halogen-free flame-retardant resin composition.

The halogen-free flame-retardant wire shown in FIG. 2 was made as follows.

A resin composition was formed by mixing 2 parts by mass of organic peroxide (Perbutyl P manufactured by NOF Corporation) with 100 parts by mass of ethylene-butene-1 copolymer rubber (TAFMER A4050S manufactured by Mitsui Chemicals) and was extruded into an inner insulation layer of 0.5 mm in thickness by a 4.5-inch continuous vapor crosslinking extruder so as to cover a tin-plated conductor (80 strands with diameter of 0.40 mm) and the inner insulation layer was then crosslinked under high-pressure steam of 1.8 MPa for 3 minutes. Next, the halogen-free flame-retardant resin composition with the components shown Table 1 was kneaded by a 14-inch roll and was extruded into an outer insulation layer of 1.7 mm in thickness by a 4.5-inch continuous vapor crosslinking extruder so as to cover the outer periphery of the inner insulation layer, and the outer insulation layer was then crosslinked under high-pressure steam of 1.8 MPa for 3 minutes.

Table 1 shows the mixed components of the halogen-free flame-retardant resin composition used in Example 1 and also shows below-described evaluation results of the halogen-free flame-retardant wire.

### Examples 2 and 3

The halogen-free flame-retardant wires were made in the same manner as Example 1 except that the components mixed in the halogen-free flame-retardant resin composition were changed to those shown in Table 1 (the type and mixed amount of metal hydroxide were changed). The evaluation results of the halogen-free flame-retardant wires are shown in Table 1.

### Examples 4 and 5

The halogen-free flame-retardant wires were made in the same manner as Example 1 except that the components mixed in the halogen-free flame-retardant resin composition were changed to those shown in Table 1 (polyethylene (PE) was used as the base polymer and the mixed amount of metal hydroxide was changed) and the outer insulation layer extruded to a thickness of 1.7 mm so as to cover the outer periphery of the inner insulation layer by a 40-mm extruder was crosslinked by exposure to 10 Mrad of electron beam.

### Example 6

The halogen-free flame-retardant wire was made in the same manner as Example 1 except that the components mixed in the halogen-free flame-retardant resin composition were changed to those shown in Table 1 (silane-grafted polyethylene (PE) was used as the base polymer and 7 parts by mass of catalyst (trade name: CT/7-LR_UV manufactured by Solvay) was mixed) and the obtained mixture was extruded into an outer insulation layer of 1.7 mm in thickness by a 40-mm extruder so as to cover the outer periphery of the inner insulation layer and the outer insulation layer was crosslinked by exposure to 10 Mrad of electron beam.

### Comparative Example 1

The halogen-free flame-retardant wire was made in the same manner as Example 1 except that the components mixed in the halogen-free flame-retardant resin composition were changed to those shown in Table 2 (the vinyl acetate content (VA content) of ethylene-vinyl acetate copolymers (EVA) used as the base polymer was 23.6 mass %, i.e., less than 25 mass %). The evaluation results of the halogen-free flame-retardant wire are shown in Table 2.

### Comparative Example 2

The halogen-free flame-retardant wire was made in the same manner as Example 1 except that the components mixed in the halogen-free flame-retardant resin composition were changed to those shown in Table 2 (the base polymer was not formed of the predetermined ethylene-vinyl acetate copolymer (EVA) or the predetermined polyethylene (PE) and the mixed amount of metal hydroxide was changed). The evaluation results of the halogen-free flame-retardant wire are shown in Table 2.

### Comparative Example 3

The halogen-free flame-retardant wire was made in the same manner as Example 1 except that the components mixed in the halogen-free flame-retardant resin composition were changed to those shown in Table 2 (the base polymer was not formed of the predetermined ethylene-vinyl acetate copolymer (EVA) or the predetermined polyethylene (PE) and the mixed amount of metal hydroxide was changed). The evaluation results of the halogen-free flame-retardant wire are shown in Table 2.

Evaluation Method of Halogen-Free Flame-Retardant Wire

The following characteristics of the halogen-free flame-retardant wire were evaluated and judged by the evaluation tests described below.

(1) Flame-Retardant Test

For evaluating flame retardancy, a vertical flame test was conducted in accordance with EN 60332-1-2. A 550 mm-long halogen-free flame-retardant wire was held vertical, a flame was applied to a position 475 mm from the upper end for 60 seconds and the flame was removed. The wires with remaining flame self-extinguished within a range of 50 mm to 540 mm from the upper end were regarded as “◯ (passed the test)” and the wires with remaining flame extended beyond this range were regarded as “X (failed the test)”.

(2) Breaking Elongation

For evaluating breaking elongation, the outer insulation layer (the outermost insulation layer) was stamped into a No. 6 dumb-bell test piece and a tensile test in accordance with in accordance with EN 60811-1-1 was conducted at a tensile speed of 200 mm/min. The test pieces having a breaking elongation of not less than 125% were regarded as “◯ (passed)” and those having a breaking elongation of less than 125% were regarded as “X (failed)”.

(3) Oil Resistance

For evaluating oil resistance, the outer insulation layer was stamped into a No. 6 dumb-bell test piece and a tensile test in accordance with in accordance with EN 60811-2-1 was conducted after 72-hour immersion in test oil, IRM 902, at 100°. The test pieces having a tensile strength retention of 130 to 70% were regarded as “◯ (passed)” and other test pieces were regarded as “X (failed)”.

(4) Mass Change Rate by Hot Xylene

For evaluating mass change rate by hot xylene, the outer insulation layer cut to 0.5 g was immersed in xylene at 110° C. for 24 hours and, immediately after this, the mass was measured and the change rate thereof was calculated. The samples with mass change rate of not more than 420% were regarded as “◯ (passed)” and those with mass change rate of more than 420% were regarded as “X (failed)”.

(5) Ease of Handling

For evaluating ease of handling, a 3000 m-long sample of the obtained wire was wound around a 1000 mm-diameter drum and was unwound after leaving for 24 hours. The wires without adhesion between the outer insulation layers (no adhesion) and without line on the surface were regarded as “◯ (passed)” and those with adhesion between the outer insulation layers (adhered) and line on the surface were regarded as “X (failed)”.

(6) Overall Evaluation

For overall evaluation, the wires which passed all tests were evaluated as “◯ (passed)” and the wires which failed any of the tests were evaluated as “X (failed)”.

As shown in Table 1, the Examples 1 to 6 passed all tests of flame retardancy, breaking elongation, oil resistance, mass change rate by hot xylene and ease of handling and the overall evaluation is thus rated as “◯ (passed)”.

On the other hand, Comparative Example 1 failed the oil resistance test. Therefore, the overall evaluation of Comparative Example 1 was “X (failed)”. In addition, Comparative Example 2 failed the tests of oil resistance, mass change rate by hot xylene and ease of handling. Therefore, the overall evaluation of Comparative Example 2 was “X (failed)”.

TABLE 1

| | Examples | | | | | |
|---|---|---|---|---|---|---|
| Items | 1 | 2 | 3 | 4 | 5 | 6 |
| EVA (VA content: 14 mass %) ¹⁾ | 65 | 65 | 65 | | | |
| EVA (VA content: 46 mass %) ²⁾ | 35 | 35 | 35 | | | |
| PE (melting point: 118° C.) ³⁾ | | | | 100 | 100 | |
| Silane-grafted PE ⁴⁾ | | | | | | 93 |
| Catalyst ⁵⁾ | | | | | | 7 |
| Organic peroxide ⁶⁾ | 2 | 2 | 2 | | | |
| Magnesium hydroxide ⁷⁾ | 150 | 300 | | 150 | 300 | |
| Aluminum hydroxide ⁸⁾ | | | 150 | | | |
| VA content in Base polymer (mass %) | 25.2 | 25.2 | 25.2 | 0 | 0 | 0 |
| Flame retardancy | ◯ | ◯ | ◯ | ◯ | ◯ | ◯ |
| Breaking elongation (%) | 300 | 160 | 310 | 170 | 130 | 180 |
| Evaluation | ◯ | ◯ | ◯ | ◯ | ◯ | ◯ |
| Oil resistance (%) | 85 | 90 | 88 | 80 | 85 | 70 |
| Evaluation | ◯ | ◯ | ◯ | ◯ | ◯ | ◯ |
| Mass change rate (%) | 190 | 160 | 195 | 230 | 220 | 420 |
| Evaluation | ◯ | ◯ | ◯ | ◯ | ◯ | ◯ |
| Ease of handling | ◯ | ◯ | ◯ | ◯ | ◯ | ◯ |
| Overall evaluation | ◯ | ◯ | ◯ | ◯ | ◯ | ◯ |

¹⁾ Trade name: EV550 from Du Pont-Mitsui Polychemicals
²⁾ Trade name: EV45X from Du Pont-Mitsui Polychemicals
³⁾ Trade name: SP1510 from Prime Polymer
⁴⁾ Trade name: GFR365 from Solvay
⁵⁾ Trade name: CT/7-LR_UV from Solvay
⁶⁾ Trade name: Perbutyl P from NOF Corporation
⁷⁾ Trade name: Kisuma 5L from Kyowa Chemical Industry
⁸⁾ Trade name: BF013STV from Nippon Light Metal

TABLE 2

| | Comparative Examples | | |
|---|---|---|---|
| | 1 | 2 | 3 |
| EVA (VA content: 14 mass %) | 70 | | |
| EVA (VA content: 46 mass %) | 30 | | |
| Ethylene-butene-1 copolymer | | 100 | |
| (melting point: 66° C.) ⁹⁾ | | | |
| Metallocene LLDPE (melting point: 111° C.) ¹⁰⁾ | | | 100 |
| Organic peroxide | 2 | | |
| Magnesium hydroxide | 150 | 300 | 300 |
| Aluminum hydroxide | | | |
| VA content in Base polymer (mass %) | 23.6 | 0 | 0 |
| Flame retardancy | ◯ | ◯ | ◯ |
| Breaking elongation (%) | 290 | 200 | 180 |
| Evaluation | ◯ | ◯ | ◯ |
| Oil resistance (%) | 68 | 40 | 50 |
| Evaluation | X | X | X |
| Mass change rate (%) | 240 | 430 | 425 |
| Evaluation | ◯ | X | X |
| Ease of handling | ◯ | ◯ | X |
| Overall evaluation | X | X | X |

⁹⁾ Trade name: TAFMER A4050S from Mitsui Chemicals
¹⁰⁾ Trade name: “Evolue ™” SP1020 from Prime Polymer

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. A halogen-free flame-retardant wire, comprising:
a conductor; and
a single insulation layer or a plurality of insulation layers formed by covering an outer periphery of the conductor with a halogen-free flame-retardant resin composition,
wherein the single insulation layer or an outermost insulation layer of the plurality of insulation layers comprises a halogen-free flame-retardant resin composition comprising:
a base polymer including an ethylene-vinyl acetate copolymer (EVA) of not less than 25 mass % in a vinyl acetate content (VA content) or a polyethylene (PE) with a melting peak at 115 to 140° C. measured by a differential scanning calorimetry (DSC); and
a metal hydroxide mixed in an amount of 150 to 300 parts by mass per 100 parts by mass of the base polymer, and
wherein a mass change rate of the single insulation layer or the outermost insulation layer after 24-hour immersion in xylene at 110° C. is not more than 420%.

2. The halogen-free flame-retardant wire according to claim 1, wherein the polyethylene (PE) is silane-grafted.

3. The halogen-free flame-retardant wire according to claim 1, wherein the base polymer further includes an acid-modified polyolefin.

4. The halogen-free flame-retardant wire according to claim 1, wherein the halogen-free flame-retardant resin composition is crosslinked.
